(19) United States
(12) Patent Application Publication
(10) Pub. No.: US 2015/0176828 A1
(43) Pub. Date: Jun. 25, 2015

(54) Light emitting diode heatsink assembly

(71) Applicant: William C. Beggs, Atlanta, GA (US)

(72) Inventor: William C. Beggs, Atlanta, GA (US)

(21) Appl. No.: 13/998,899

(22) Filed: Dec. 19, 2013

(51) Int. Cl. F21V 29/00; F21K 99/00

(52) U.S. Cl. CPC F21V 29/22; F21K 9/30

(57) ABSTRACT

The efficiency of one or more LED installations is achieved by holding the junction temperature of an LED at a low level by soldering the LED die to a small threaded metallic piece, such as a nut, which is then clamped to a larger piece having a lower thermal resistance to the air or other heat conducting medium surrounding the combination. Each of the die-nut subassemblies can be fastened to the larger metallic piece closely together without endangering any previously fastened die-nut subassemblies, thus achieving denser groups of installed LEDs. Assemblies according to this invention can operate efficiently in an electrical system several thousand meters long.

This is a non-provisional application which claims the filing date of the same applicant's provisional application, Ser. No. 61/848,088, filed in the United States Patent and Trademark Office on Dec. 26, 2012.

Disclosed is a method for achieving more light output from LEDs (Light Emitting Diodes). Also disclosed is a method for efficiently powering LEDs when powered through electrical systems of great length.

### BACKGROUND OF THE INVENTION

The individual LED operates in the 3 to 10 volt range. In addition to light, it also puts off a small amount of heat. When this heat is not carried away rapidly the temperature of the LED rises until equilibrium of heat production and heat removal is reached. As the LED temperature rises the light output decreases. The heat passes through various “heatsink” arrangements to the air outside the fixture. Small “heatsinks” cost less than large “heatsinks” of the same material.

### BRIEF SUMMARY OF THE INVENTION

The efficiency of one or more LED installations is achieved by holding the junction temperature of an LED at a low level by soldering the LED die to a small threaded metallic piece, such as a nut, which is then clamped to a larger metallic piece having a lower thermal resistance to the air or other heat conducting medium surrounding the combination. Each of the die-nut subassemblies can be fastened to the larger metallic piece closely together without endangering any previously fastened die-nut subassemblies, thus achieving denser groups of installed LEDs.

### BRIEF DESCRIPTION OF THE DRAWINGS

FIG. 1 is an enlarged view partly in section of an LED assembled to a section of copper plate in accordance with this invention.

FIG. 2 is a sectional and partially perspective view of an application of the present invention in a lamp.

### DETAILED DESCRIPTION OF THE INVENTION

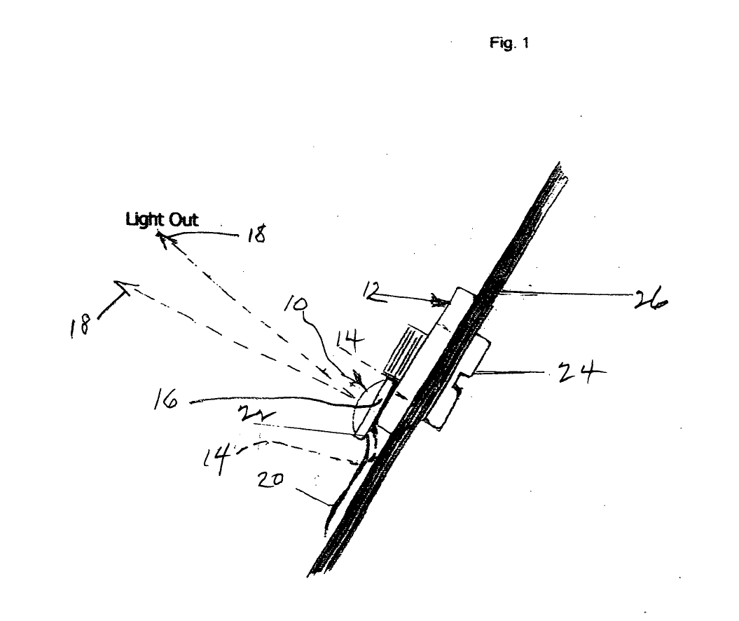

Referring to FIG. 1, the LED 10 is initially assembled, as a sub-assembly, to a brass nut 12 with a metallic solder 14. Nut 12 may also be copper or similar ready heat conducting material, and may be a hex nut for easy handling. Preferably nut 12 has a surface area outside of its central threaded aperture large enough to arrange a heatsink surface of an LED upon, leaving only enough overhang of the LED's heatsink for a power source connection to the LED. The metallic solder 14 connects the LED 10's first electrode and heatsink terminal 16 to nut 12. Light to be emitted from the LED is designated with the arrows 18. Brass nut 12 may be a 6/32 inch brass hex nut, and all but a small portion of the LED 10's terminal 16 is disposed upon it. A conductor wire 20 from a power source (not shown) extends from the LED's second electrode 22 immediately adjacent to the nut 12. It will be immediately apparent that the nut 12 is disposed to receive the initial load of heat emanating from LED 10.

When LED 10 and nut 12 are fixed together, a clamping member such as binder head brass screw 24, nominally 6/32 inches by ⅜ inches long, is inserted through copper plate 26 to threadably engage brass nut 12 and clamp it snugly against plate 26. Plate 26 may be a flat plate, or it may be shaped to fit applications where a different configuration is needed. The engagement of the brass nut on plate 26 enables heat in the nut 12 emanating from LED 10 to be transferred from the nut to a much larger member, namely, plate 26. That plate may be disposed in air, in a liquid, or an alternative coolant to quickly disperse the heat from the plate.

The disposition of LED 10's first terminal and heatsink 16 almost entirely on the nut 12, and, in turn, the disposition of the nut on the much larger member 26, holds the LED junction temperature to a very low level, permits the heat generated by the LED to be rapidly dispersed, and increases the light output from the LED.

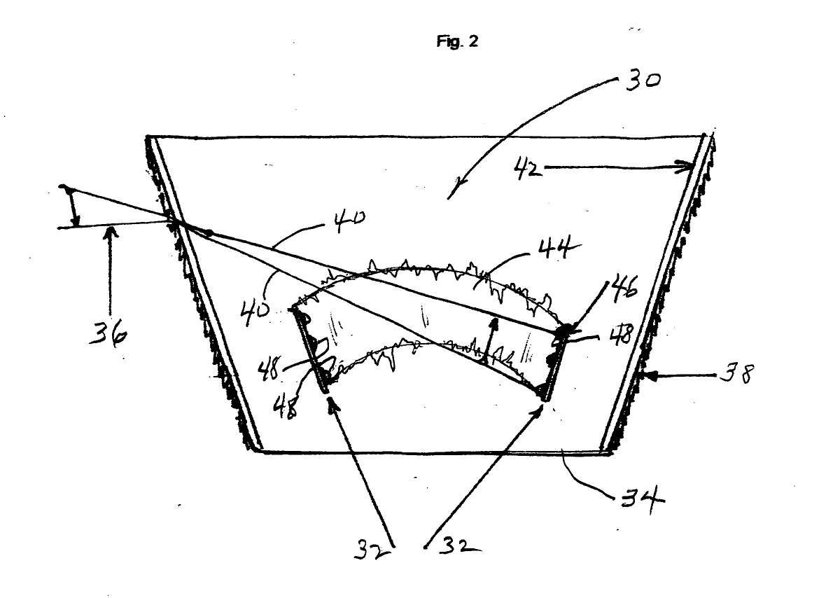

An application of the foregoing diode and heatsink assembly is illustrated in FIG. 2. An optical system 30 is shown which includes an LED and heatsink assembly 32 as a source of light inside a conically shaped lens 34. The system is designed for transmitting a beam 36 in the far field of the lens. A full discussion of the lens, utilizing a different light source, may be found in U.S. Pat. No. 4,745,343, issued May 17, 1988 and entitled “Panoramic Optical System with Very Sharp Beam Control.” The lens described in that patent, and shown as 34 in the above FIG. 2, has an outer surface 38 which is formed to hinge light rays 40 from light source 32 to produce beam 36. The lens inner surface 42 is covered with Blondel prisms, each of which spreads the light rays 40 horizontally about twenty to thirty degrees, thus assisting in keeping the beam formed by the light rays 40 in a uniform pattern.

In FIG. 2, a copper plate 44 is formed in the shape of a cone to fit inside the lens 34, with the inner sides of plate 44 disposed in the focal plane 46 of LEDs 48 in the assembly 32. A plurality of the LEDs 48 is disposed on brass nuts clamped onto copper plate 44 in the manner described above concerning FIG. 1. It has been found that a large number of LEDs may be assembled in this manner on a copper plate fitted into a lens having a diameter of 8.5 inches at its upper, larger end and a diameter of 6.5 inches at its lower, smaller end and a Type V (omnidirectional) light distribution. This embodiment utilized 42 LEDs distributed around the inside of the cone formed by copper plate 44, and it easily dissipated the heat generated by the LEDs into the air inside lens 34.

LEDs operating at approximately 10 volts junction-plus-ballast volts are a low impedance load. To operate efficiently in an electrical system several thousand meters long a multiphase transformer will transform the low impedance LED load according to a customer's needs as shown in U.S. Pat. No. 4,099,066, issued Jul. 4, 1978 and entitled “Pulse Generating System with High Energy Electrical Pulse Transformer and Method of Generating Pulses.”

While particular embodiments of the present invention have been shown, it will be understood, of course, that the invention is not limited thereto since modifications may be made by those skilled in the art. It is, therefore, contemplated by the appended claims to cover any such modifications as come within the true spirit and scope of the invention.

I claim:

1. A light emitting diode assembly comprising
a light emitting diode,
a plate member configured for rapid dispersal of heat generated by the diode into a medium surrounding the plate, and
an intermediate member forming a junction between the diode and the plate member configured to transmit heat generated by the diode to the plate member and to maintain the temperature at the junction below an equilibrium of heat from the diode and heat disbursed by the plate member.

2. The light emitting diode assembly of claim 1 in which the plate member is copper or aluminum.

3. The light emitting diode assembly of claim 1 is cone shaped.

4. The light emitting diode assembly of claim 1 in which the intermediate member is a hex nut.

5. The light emitting diode assembly of claim 4 in which the hex nut is soldered to a first electrode of the diode.

6. The light emitting diode assembly of claim 5 in which an electrical power conductor from a powersource is connected to the diode adjacent the hex nut.

7. The light emitting diode assembly of claim 4 in which the intermediate member is clamped to the plate member.

8. A light emitting diode assembly comprising
a plurality of light emitting diodes,
a plate member having a configuration for rapid dispersal of heat generated by the diodes into a medium surrounding the plate member, and
an intermediate member for each diode forming a junction between the diode and the plate member and configured to transmit heat from the diode to the plate member and maintain the temperature at the junction below an equilibrium of heat from the diode and heat dispersed by the plate member.
